(19) United States
(12) Patent Application Publication
(10) Pub. No.: US 2006/0273974 A1
(43) Pub. Date: Dec. 7, 2006

(54) Dual polarised antenna device for an antenna array and method for manufacturing the same

(75) Inventors: Jan Geralt Bij De Vaate, Diever (NL); Johannes Henricus Pragt, Coevorden (NL); Huub Ehlhardt, Den Bosch (NL)

Correspondence Address: MICHAELSON & ASSOCIATES, P.O. BOX 8489, RED BANK, NJ, 07701, US

(73) Assignee: Stichting Astron

(21) Appl. No.: 10/565,722

(22) PCT Filed: Jul. 6, 2004
(86) PCT No.: PCT/NL04/00481

§ 371 Date: Jun. 5, 2006

(30) Foreign Application Priority Data
Jul. 25, 2003 (NL) 1024005

(51) Int. Cl. H01Q 13/10

(52) U.S. Cl. 343/770

(57) ABSTRACT

An antenna device (1, 1′, 1″) comprising: a sheet-shaped support (2) which is folded along a fold-line (3-8, 80-83). The support (2) includes a first support (10-13) plane adjacent to said fold-lines (3-8, 80-83) and a second support plane (10-13) adjacent to a of said fold-lines (3-8, 80-83). The first support plane (10-13) has a first antenna structure (100) arranged for receiving or emitting electro-magnetic radiation and the second support plane (10-13) has a second antenna structure (100) arranged for receiving or emitting electro-magnetic radiation. The second support plane is (10-13) positioned at an angle with respect to the first support plane (10-13). The second antenna structure (100) is sensitive to electro-magnetic radiation which differs in a property to the electro-magnetic radiation to which said first antenna structure (100) is sensitive.

The invention relates to an antenna device. The invention further relates to an antenna array, an intermediate product for an antenna device and a method for manufacturing an antenna device.

Antenna devices are generally known and used for receiving and emitting electro-magnetic radiation and may, for example, be employed in radar and other direction finding systems, astronomical observatories and satellite receiving equipment, for example. Often, an antenna device has to receive or emit electro-magnetic radiation with differing spatial properties, for example electro-magnetic radiation with different directions of polarisation or electro-magnetic radiation stemming from different sources (and, accordingly, emitted from different positions).

For instance, for receiving electro-magnetic radiation with different polarisations dual polarised antenna device are known. A dual polarised phased array antenna is known, for example, from the European patent publication 0 349 069 A1. This prior art document describes a phased array antenna having a plurality of antenna elements positioned in a matrix-shaped arrangement. The matrix comprises an assembly of two orthogonal sets of parallel insulating planar supports. Each of the insulating planar supports is provided with a conductive surface layer patterned to form a succession of tapered notch antenna elements. The tapered notch antenna elements are distributed along an outward facing edge of the planar support. Each of the tapered notch antenna elements has a polarisation parallel to the planar supports. The phased array antenna thus comprises two orthogonal sets of line-shaped arrangements of tapered notch antenna elements, of which sets each has a respective, orthogonal polarisation.

In the phased array antenna described in the above mentioned patent publication, the insulating planar supports of each set intersect and engage on the supports of the other set. To that end, the supports are provided with a slot extending from the edge of a planar support to half way across the support. The sets are positioned such that the supports of one set extend in the slots of supports of the other sets. The supports of one set thus intersect and engage with the supports of the other set to form a matrix-shaped support structure.

However, a draw-back of the antenna device described in said patent publication is that each planar support has to be provided with a multitude of slots, in which thereafter the supports of the other sets have be positioned. Accordingly, manufacturing of the dual polarised phased array antenna is complex. Furthermore, the planar supports have to be made of a rigid material in order to obtain a support construction with sufficiently high stiffness, which limits the choice of materials which can be used in the antenna device.

It is an object of the invention to provide an antenna device which can receive or emit electro-magnetic radiation with different spatial properties and which can be manufactured in a less complex manner. Therefore, according to the invention an antenna device is provided according to claim 1.

Such an antenna device can be manufactured by folding a suitable intermediate product, e.g. blank. Compared to cutting slots into rigid supports and positioning sets of slotted rigid supports in a matrix arrangement, folding is a simple operation with few steps. The antenna device can receive or emit electro-magnetic radiation with different spatial properties because the first support plane has a first antenna structure and the second support plane is positioned at an angle with respect to the first support plane and has a second antenna structure.

Furthermore, the at least one sheet-shaped support is folded along at least one fold-line, which has the additional advantage that the mechanical stiffness of the antenna device is increased. A wider variety of material can thus be used for the supports, since less rigid, even flexible, materials can be used, such as for instance a foldable plastic sheet material such as kapton.

Furthermore, an antenna array according to claim 19 is provided. Such an antenna array can be manufactured in a simple manner, by suitable folding of one or more intermediate products.

An intermediate product according to claim 22 is also provided. An antenna device can be manufactured in a simple operation from such intermediate product by suitable folding of the support along one or more fold-lines.

A method according to claim 23 is provided as well. In such a method, an antenna device or antenna array is manufactured in a simple manner.

Specific embodiments of the invention are set forth in the dependent claims. Further-details, aspects and embodiments of the invention will be described, by way of example only, with reference to the figures in the attached drawings.

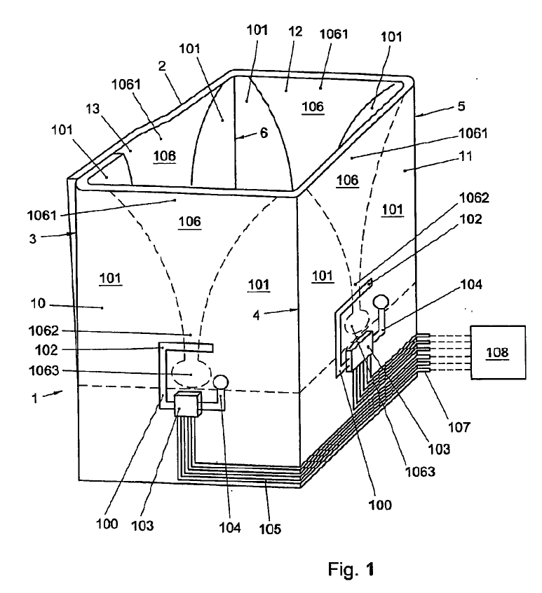

FIG. 1 schematically shows a perspective view of an example of an embodiment of an antenna device according to the invention.

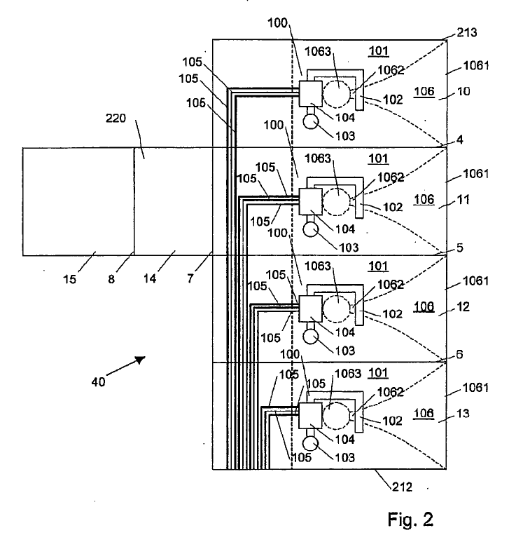

FIG. 2 schematically shows a top view of an example of an embodiment of a semi-finished product suitable for manufacturing an antenna device according to the invention.

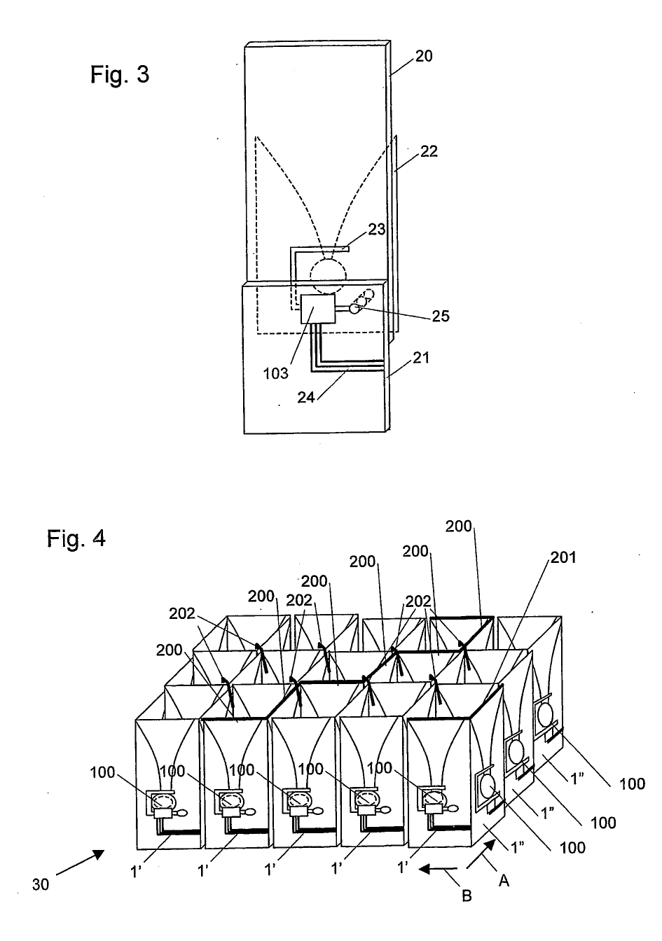

FIG. 3 schematically shows a perspective, partially exploded view of a part of the semi-finished product of FIG. 2.

FIG. 4 schematically shows a perspective view of an example of an embodiment of an antenna array according to the invention.

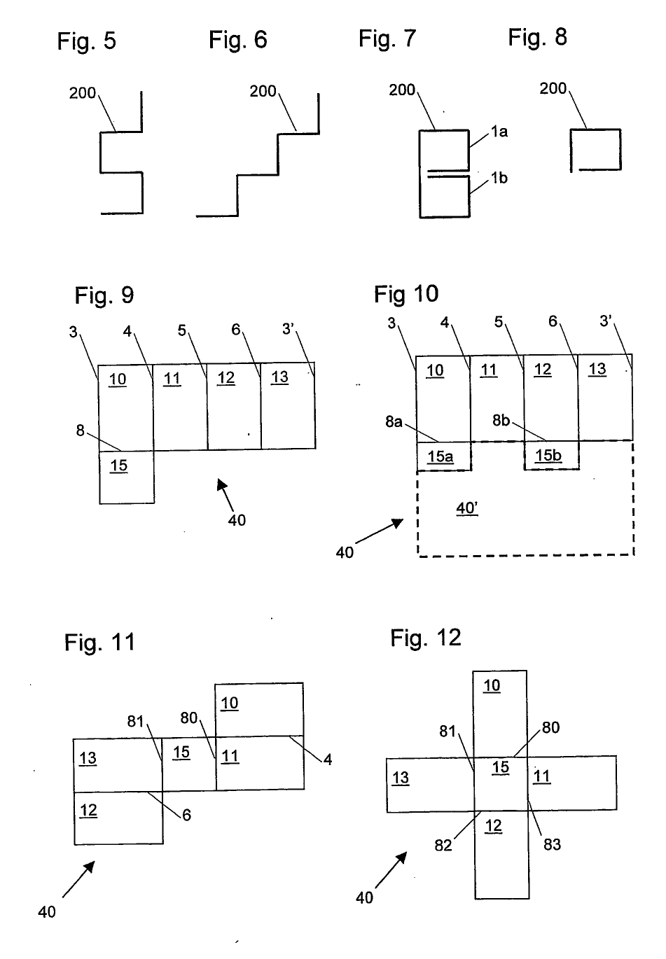

FIG. 5-8 schematically show examples of folded sheets shaped supports suitable for in an example of an embodiment of an antenna array according to the invention

FIG. 9-12 schematically show some examples of sheet shaped intermediate product suitable for manufacturing an example of an embodiment of an antenna device according to the invention.

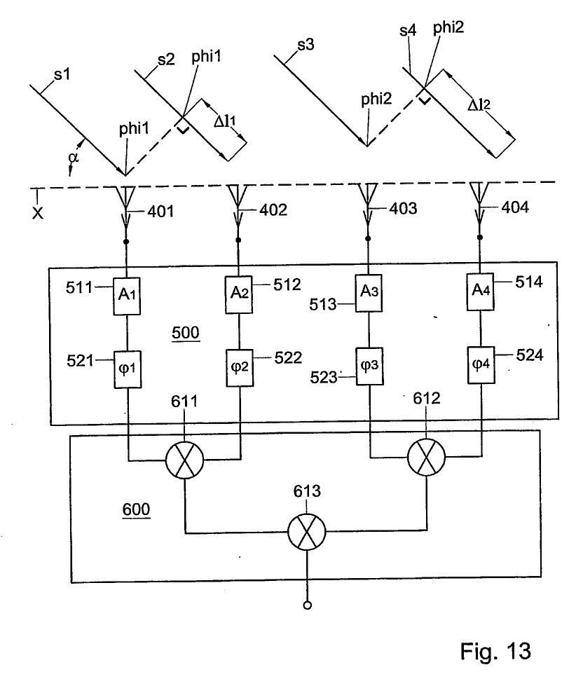

FIG. 13 schematically shows a block diagram of an example of an embodiment of a phased array antenna.

FIG. 1 shows an example of an embodiment of an antenna device 1. The antenna device 1 comprises a sheet-shaped support 2 which is folded along one or more, in this example four, fold-lines 3-6. Support planes 10-13 are present between the fold-lines 3-6, which support planes are obtained by means of the folding.

Each of the support planes 10-13 is provided with an antenna structure 100. In this example, the antenna structures 100 each have an electro-magnetic polarisation direction which is coplanar with the plane of the support plane on which the antenna structure 100 is formed. Thus, by folding the sheet shaped support 2 along the respective fold-lines 3-7, an antenna device with antenna structures 100 is obtained in a simple manner, which can receive or emit spatially different electro-magnetic radiation, e.g. differently polarised radiation.

However, the antenna structures may likewise be sensitive to radiation which differs in another spatial aspect. For example, the antenna structures may be sensitive to electromagnetic radiation from different directions and/or for example comprise so called horizontal antennas. Horizontal antennas are flat antennas sensitive to incident radiation with at least a radiation component orthogonal with respect to the plane in which the antennas lie whereas vertical antennas are sensitive to incident radiation with at least a radiation component parallel to the plane of the antennas. Thus, if a sheet-shaped support comprising two or more horizontal antenna structures is folded along fold-lines, such that two or more support planes each with one or more horizontal antenna structures are obtained, the antenna structures on the respective planes are sensitive to radiation from different directions.

The sheet shaped support 2 may be made of any foldable material suitable for the specific implementation. The antenna device 1 has an increased mechanical stiffness because of the fold-lines, which allows the support 2 to be made of a flexible material, which can be folded with a small amount of bending force. The flexible material may for example be a thin plastic foil, kapton, Mylar, Teflon, poly propylene, Poly ethylene or otherwise.

In the example of FIG. 1, the antenna structures 100 include a vertical antenna, but the antenna structures may include other types of antennas. In the example, the antenna structure 100 comprises a patterned conductive surface layer 10 which extends over at least a part of the respective support planes 10-13. The conductive layer 101 is provided with a slot 106. The slot 106 has a tapered shape which narrows from an open, wide end 1061 at an edge of the support plane 10-13 towards a narrow end 1062 at a distance from the edge. At the narrow end, the slot 106 mounds in a circular space 1063.

The antenna structure 100 in the example of FIG. 1, is of a type which is sometimes called a Vivaldi antenna. Such antennas are generally known in the art, for example from the European patent publication 0 349 069 A1 and United Kingdom Patent Number GB 1 601 441. The description of a Vivaldi antenna is hereby assumed to be incorporated herein by way of reference and for this reason the antenna structure will not be further described in detail herein. The Vivaldi antenna element provides an electrical polarisation direction which is coplanar with the plane of the dielectric plate on which it is formed.

In the example of FIG. 1, a feed 102 extends across the tapered slot 106 at the narrow end 1062. The feed 102 is connected to an signal input of an amplifier 103, in this example a low noise amplifier, while a reference input of the amplifier 103 is connected to a ground 104. The amplifiers of the antenna structures 100 are further connected to a suitable control circuit and/or signal processing circuit 108 via contact lines 105 and connectors 107. A signal from the feed 102 can for example be transmitted to a signal processing circuit via the amplifier 103, the contact lines 105 and the connectors 107, while a suitable power supply can be provided to the amplifier 103 via the contact lines 105 and the connectors 107.

The connection between the antenna device and additional electronic circuitry may be implemented in any manner suitable for the specific implementation. For instance, a capacitive, inductive or other connection without physical contact can be used.

In the example of FIG. 1, the fold-lines 3-6 are parallel to each other and positioned at equal distances from each other. However, the fold-lines may be positioned in a non-parallel arrangement with respect to each other and/or a different spacing maybe present between the fold-lines. The sheet-shaped support 2 is folded along the fold-lines 3-6 into support planes which are perpendicular to each other. Accordingly, the folded sheet-shaped support 2 encloses a square shaped area. However, the sheet shaped support 2 may likewise be folded in a different manner. For example, the support planes 10-13 may be positioned at another angle with respect to each other, more or less support planes may be present. For instance, three support planes may be provided positioned at an angle of more or less 60 degrees with respect to each other.

In FIG. 1, the sheet-shaped support 2 is folded into a sleeve-like shape, with an open top and bottom. However, the sheet-shaped support 2 may be folded into another shape and/or with more or less open sides. The blank 40 shown in FIG. 2, for example, has, when folded into an antenna device, a closed bottom side which forms a base plane 15 of the antenna device.

FIG. 2 shows a top view of an example of an intermediate product, e.g. a blank 40, which can be folded to obtain an antenna device. The blank 40 comprises an elongated sheet-shaped support 2 provided with two or more, in this example four, flat antenna structures 100 arranged along the longitudinal direction of the sheet shaped support 2. The sheet-shaped support 2 is foldable along fold-lines 4-6 which extend across the sheet-shaped support 2 from one of the longitudinal edges 210,211 to the other longitudinal edge 211. The fold-lines divide the sheet-shaped support 2 into support planes 10-13, each of which has an antenna structure 100. An antenna device according to the invention can be manufactured from the blank 40 by folding the sheet-shaped support 2 along the fold-lines 4-6, such that the short edges 212,213 of the elongated support 2 are in contact with each other. By folding the blank 40 in this manner, a sleeve-shaped antenna device can be obtained.

In the example of FIG. 2, the support 2 further has at the longitudinal edge 210 an extension 220 adjacent to the support plane 11. The extension 220 is foldable along fold-line 7 with respect to the rest of the sheet-shaped support 2. The fold-line 7 extends in a direction transverse to the fold-lines 4-6 and parallel to the longitudinal edge 210. The extension 220 further has a fold-line 8 at a distance from and parallel to the fold-line 7. The fold-line 8 divides the extension into a plane 14 and a base plane 15. By suitable folding of the extension 220 along fold-lines 7 and 8, the base plane 15 of the extension 220 can be used as a bottom closure of the sleeve. Thus, a box-shaped antenna device can be obtained. For instance, the plane 14 can be folded along fold-line 7 such that the plane 14 lies parallel to and against the support plane 11. The base plane 18 can then be folded along the fold-line 8 which divides the extension 20, to extend transverse to the support plane 11 and form the base plane of an antenna device.

In the example of FIG. 2, the base plane 15 is covered at one side with a conducting layer, such as for example a metallic layer or otherwise. By suitable folding the extension 220, the base plane 15 can be positioned with its conductive layer in contact with the conductive layer 101 on the support planes 10-13. In such case, the base plane 15 forms the bottom of the box-shaped folded support as well as an electrical base plane for the antennas device. For instance in the example of FIG. 2, the conductive layer 101 of the antenna structures 100 extends over a part of the width of the sheet-shaped support 2 only, as indicated with the dashed line parallel to and between the longitudinal edges 210,211. The fold-line 8 lies as far from the fold-line 7 as the edge of the conductive layer 101, indicated with the dashed line, lies from the longitudinal edge 210 of the sheet-shaped support 2. Thus, after folding, the fold-line 8 then lies against the edge of the conductive layer 101, indicated with the dashed line.

The invention is not limited to the arrangement of fold-lines and support planes shown in FIG. 2 and other arrangements are likewise possible. For instance FIGS. 9-12 show, by way of example only, blanks 40 with alternative arrangements of the fold-lines and support planes.

In the example of FIG. 9 the support planes 10-13 are positioned in a line shaped arrangement and foldable along fold-lines 4-7 such that the lines 3,3′ at the short ends of the blank 4 are positioned in contact with each other. A base plane extension 15 is positioned at the lowerside of support plane 10 to form the base plane after folding along the fold-line 8. The example of FIG. 10 comprises two base-plane extensions 15a, 15b which extend over half the length of the base plane after folding. Such an extension arrangement allows to manufacture the support plane from a band of support plane material with negligible loss of material, because two support planes blanks 40,40′ can be cut from the band, as is indicated in FIG. 10 with the dashed lines.

In the example of FIGS. 11 and 12, the support planes 11,13 resp. 10-13 are connected to each other via the base plane which can be formed by folding along fold-lines 80,81 resp. 80-83. Thereby the respective support planes 13,11 resp. 10-13 adjacent to the base plane 15 are in contact with the base plane, and when the base plane has to be an electrical base plane, electrical contact between the base plane 15 and the adjacent support planes is ensured. Furthermore, the examples of FIGS. 11 and 12 can be modified easily to obtain an antenna device with a frustrated pyramid-like shape by providing the support planes 11,13 resp, 10-13 with a trapezoid shape.

The antenna structure 100 and the sheet-shaped support 2 may be implemented in any manner suitable for the specific implementation. As shown in FIG. 3, the sheet-shaped support 2 and/or the antenna structures 100 may for instance be a multilayer structure. A multilayer structure can for instance be used to integrate two or more functions of the antenna device. In the example of FIG. 3, the tapered notch antenna, the feed and the connection of the antenna device are integrated.

In FIG. 3, the sheet-shaped support 2 comprises a first electrically isolating layer 20, which may for instance be made out of a plastic material, such as polyethylene, polypropylene, cartboard, kapton or otherwise. The first electrically isolating layer 20 is provided at a backside with a first electrically conductive layer 22.

The first electrically conductive layer 22, for example, may be provided in a relatively simple manner, by adhering a conductive foil, such as aluminium foil, to the backside of the electrically isolating layer 20. Techniques for fixating aluminium foil onto a plastic layer; such as polypropylene or polyethylene, are generally known, for example in the field of packaging food products and are for the sake of brevity not described in further detail. However, the electrically conductive layer 22 may be obtained in any other manner suitable for the specific implementation.

A second electrically conducting layer 23 is present at a front side, opposite to the backside, of the first electrically isolating layer 20. The second electrically conducting layer 23 can, for instance, be strip-shaped and be formed into the feed 102 of an antenna structure 100 suitable for the example of FIG. 1.

The strip-shaped electrically conducting layer 23 lies between the first electrically isolating layer 20 and a second electrically isolating layer 21. A third electrically conducting layer 24 lies on top of the second electrically isolating layer 21, which is shaped into a ground connection of an amplifier 103 or other electronic circuitry present in the antenna structure 100. The ground connection in the third electrically conducting layer 24 is connectable to the first electrically conducting layer 22 by means of a passage 25 in which an electrically conducting pin can be positioned which then connects the first and third electrically conducting layers 22,24 electrically. The third electrically conducting layer is further shaped into connecting lines 105 for transmitting signals from or to the antenna. Thus, the connecting lines 105 are integrated in the flat design of the antenna structures 100. Thereby, the antenna structures 100 can be connected to further circuitry in a simple manner and there is no necessity to connect cables directly to the amplifier 103 of the feed 102.

FIG. 4 shows an example of an antenna array 30 which includes two or more examples of antenna devices 1′, 1″ according to the invention. As indicated in FIG. 4 by way of example with reference numbers 200,201, the antenna array comprises one or more step shaped folded supports provided with antenna structures. The step-shaped folded supports 200,201 are folded into a number of antenna devices 1′,1″ according to the invention. The antenna devices 1′, 1″ are provided with antenna structures 100 each have an electro-magnetic polarisation direction which is coplanar with the plane of the support plane on which the antenna structure 100 is formed. The antenna array 30 therefore comprises sets of antenna device 1′ resp. 1″ with different orthogonal orientations, as indicated with the arrows A and B, and the antenna array 30 is a dual polarised antenna array which can be used to receive or emit electro-magnetic radiation with different polarisations.

Additionally, each set of antenna devices 1′ resp. 1″ comprises arrangements of antenna device 1′ resp. 1″ in the direction of arrow A and arrangements in the direction of arrow B. Accordingly, each set forms a matrix-shaped arrangement with a certain polarisation and the antenna array 30 shown in FIG. 4 comprises two, intermingled matrix-shaped arrangements each of which has a different polarisation.

In FIG. 4, the antenna devices 1′1,″ are positioned in a two-dimensional matrix shaped arrangement. It should be noted that in general any number of antenna elements may be used and the invention is not limited to the shown number of antenna elements. Furthermore, the antenna elements may likewise be positioned in an arrangement different from the line-shaped arrangement in FIG. 4 such as, depending on the specific implementation, a line-shaped arrangement, a random distribution, a three dimensional arrangement or otherwise.

In the example of FIG. 4, the support 200 is folded along more than one fold-line. The support 200 is repeatedly folded along a fold-line in a first direction and in a following fold-line in a second direction opposite to the first direction, such that a stair-shaped support is obtained, as is for instance shown in FIG. 6. A number of supports folded in a similar fashion is positioned parallel to the support 200. However, the invention is not limited to the specific manner in which the support 200 is folded. The supports may likewise be folded in another manner. FIG. 5, for example, shows a support 200 which is folded along a first pair of fold-lines in a first direction and a following pair of fold-lines in a second direction, such that the support is locally U-shaped. FIG. 7 shows a support which is first folded along a first set of three equally spaced fold-lines in a first direction and then again along a second set of three equally spaced fold-lines at that same direction, to obtain two sleeve shaped antenna devices 1a and 1b.

In the antenna array 30 shown in FIG. 4, the supports are attached near the fold-lines to each other by means of clamps 202. A fixation by means of clamps is low-cost and non-complex. However, the supports may likewise be attached in another manner. For instance of different sheets may be glued to each other in the support planes or otherwise.

The antenna array system shown in FIG. 4 may be implemented as a phased array antenna. For instance, by connecting the different sets of antenna devices 1′ resp. 1″ to suitable beam forming and control circuitry. Phased array antennas are generally known, for instance from the American patent publication U.S. Pat. No. 6,232,919 and the European patent publication EP 805 509.

In FIG. 13, the operation of such an antenna system is illustrated. The antenna system shown comprises, by way of example, four antenna units 401-404 which are arranged next to each other in one line. The antenna units 401-404 are each connected with an amplifier device 511-514. The amplifier devices 511-514 are each connected with a time- or phase-shifting circuit 521-524. The time- or phase-shifting circuits 521-524 are connected with each other through combining circuits 611-613 in an electronic circuit 600. The antenna system shown in FIG. 4 could be designed as a phased array antenna system, for instance by adding time- or phase-shifting circuits, for instance via different lengths of the contact lines 105, implementing the amplifier devices 103 in the signal processing circuit 500 and connecting the contact lines 105 to a suitable electronic circuit.

The antenna units 401-404 can receive electromagnetic radiation which reaches the antenna at an angle which is within the viewing range. In FIG. 7 a bundle of electromagnetic radiation is shown which is built up from four parallel rays s1-s4. In the example shown, the ray s1 incident on the antenna unit 401 has a phase phi1. The ray s2 incident on the antenna unit 402, however, must cover an additional distance Δ1₁, which is equal to the distance between the antenna units multiplied by the cosine of the angle α which the rays make with the plane X in which the antenna units are situated. As a result, the ray s2 has a phase shift relative to the ray s1 at the moment when the antenna is reached. The phases of the rays s3 and s4 differ similarly. In the antenna system, this phase shift can be compensated by setting the phase- or time-shift of the phase- or time-shifting circuits 521-524, such that the mutual differences thereof correspond to the phase differences in the incoming rays. In this way, because the phase- or time-shift depends on the angle of the incoming radiation, the direction in which the antenna system receives can be adjusted.

By designing an antenna system according to the invention as a phased array antenna, an inexpensive antenna unit is obtained which can be simply directed electronically at a source by setting the time- or phase-shifting circuits. Moreover, several sources can be received simultaneously, by connecting each of the antenna units with several time- or phase-shifting circuits and setting a separate shift for each source to be received. Further, with a phased array antenna, a rotation of the antenna system relative to the source can be automatically compensated electronically. For instance satellite receivers mounted on ships and trucks, and in general on moving carriers, are subject to such rotation, so that the known receiver, at least the antennas thereof, must be held in position mechanically. With a phased array antenna system as proposed, this mechanical compensation can be replaced with an electronic compensation, which is cheaper and more wear-resistant.

It should be noted that the above-mentioned embodiments illustrate rather than limit the invention, and that those skilled in the art will be able to design alternatives without departing from the scope of the appended claims. For instance, a line of weakness may be provided to the sheet shaped support to facilitate the folding. Also, the fold-lines may, for example, be provided at other positions of the support than shown and/or the support planes may be oriented differently with respect to each other. Furthermore, the antenna device may for example comprise more or less support planes. Also, the antenna device may be positioned in recesses of a cover shielding the antenna device from environmental influences, such as water, temperature or otherwise. Such a cover may for example be made of a foam material and, for instance, be provided with one or more slots corresponding to the shape of the support. Other variations and modifications are likewise possible and features from different embodiments may be combined.

In the claims, any reference signs placed between parentheses shall not be construed as limiting the claim. The word ‘comprising’ does not exclude the presence of other elements or steps than those listed in a claim. Unless explicitly specified otherwise, the word ‘a’ is used as including one, two, three, or more of the specified elements. The mere fact that certain measures are recited in mutually different claims does not indicate that a combination of these measures cannot be used to advantage.

1. An antenna device (1, 1′, 1″), comprising:
at least one sheet-shaped support (2) which is folded along at least one fold-line (3-8, 80-83), said support (2) including:
at least one first support plane (10-13) adjacent to at least one of said fold-lines (3-8, 80-83), which first support plane (10-13) has at least one first antenna structure (100) arranged for receiving or emitting electro-magnetic radiation; and
at least one second support plane (10-13) adjacent to at least one of said fold-lines (3-8, 80-83), which second support plane (10-13) is positioned at an angle with respect to the first support plane (10-13) and which second support plane (10-13) has at least one second antenna structure (100) arranged for receiving or emitting electro-magnetic radiation.

2. An antenna device (1, 1′, 1″) as claimed in claim 1, wherein
at least one of the first antenna structures (100) is arranged for receiving or emitting electro-magnetic radiation of a first polarization; and wherein
at least one of the second antenna structures (100) is arranged for receiving or emitting electro-magnetic radiation of a second polarization different from said first polarization.

3. An antenna device (1, 1′, 1″) as claimed in claim 1, wherein the support (2) is folded along at least two fold-lines (3-8, 80-83), and further comprises a base plane (15, 15a, 15b) adjacent to a side of a fold-line (3-8, 80-83), at least one of the first and second support plane (10-13) being adjacent to another side of that fold-line (3-8,80-83); and
said base plane (15,15a, 15b) being positioned at an angle with respect to the first and second support plane (10-13).

4. An antenna device (1, 1′, 1″) as claimed in claim 1, wherein the support (2) comprises an electrically isolating layer (20,21).

5. An antenna device (1, 1′, 1″) as claimed in claim 4, wherein the electrically isolating-layer (20,21) is made of a flexible material.

6. An antenna device (1, 1′, 1″) as claimed in claim 4 or 5, further comprising:
a first electrically conducting layer (22) at a first side of the electrically isolating layer (20, 21); and
and an electrically conducting layer (23) at a second side of the electrically isolating layer (20,21) shaped into a feed (102).

7. An antenna device (1, 1′, 1″) as claimed in claim 4, further comprising a second electrically conductive layer (24) at the second side of the electrically isolating layer (20,21) shaped into connecting lines (105) for transmitting signals from or to the antenna structure (100).

8. An antenna device (1, 1′, 1″) as claimed in claim 7, wherein
the feed (102) lies between a first electrically isolating layer (20) and a second electrically isolating layer (21); and wherein
the connecting lines (105) are present at a side of the second electrically isolating layer (21) facing away from the first electrically isolating layer (20).

9. An antenna device (1, 1′, 1″) as claimed in claims 3 and 6, wherein the first conducting layer (22) extends at least partially over at least a part of the base plane (15, 15a, 15b).

10. An antenna device (1, 1′, 1″) as claimed in claim 6, further comprising an amplifier element (103) positioned at the second side, which amplifier element (103) is electrically connected with a signal input to the feed (102) and is connected with a reference input to a ground (104).

11. An antenna device (1, 1′, 1″) as claimed in claim 6, wherein the first conducting layer (22) is used as ground (104).

12. An antenna device (1, 1′, 1″) as claimed in claim 1, wherein the antenna structures (100) include flat antennas.

13. An antenna device (1, 1′, 1″) as claimed in claim 12, wherein the antenna structures (100) include vertical antennas.

14. An antenna device (1, 1′, 1″) as claimed in claim 13, wherein the antenna structures (100) include tapered slot antennas.

15. An antenna device (1, 1′, 1″) as claimed in claim 1, wherein the support (2) is folded along at least one of said fold-lines (3-8, 80-83) such that at least one of the first support plane (10-13), the second support plane (10-13), and the base plane (15, 15a, 15b) is positioned substantially perpendicular to at least one of the other planes.

16. An antenna device (1, 1′, 1″) as claimed in claim 3, wherein the base plane (15, 15a, 15b) is substantially rectangular, said first support plane (10-13) is positioned at a first side of the rectangular base plane (15, 15a, 15b) and said second support plane (10-13) is positioned at a second side of the rectangular base plane (15, 15a, 15b) transverse to the first side.

17. An antenna device as claimed in claim 1, wherein the support plane is folded to a sleeve-like shape.

18. An antenna device as claimed in claim 1, wherein at least one of the antenna structures is connectable to further signal processing devices outside the antenna device via a non-contact connection, such as a capacitive or an inductive connection.

19. An antenna array (30) comprising at least two antenna devices (1′, 1″) as claimed in claim 1.

20. An antenna array (30) as claimed in claim 19, comprising at least one sheet shaped support member (200, 201) which is folded along at least two fold-lines (3-8, 80-83) to obtain at least two antenna devices (1, 1′, 1″) as claimed in claim 1.

21. An antenna array as claimed in claim 20, wherein the sheet shaped supports (200, 201) are connected to each other at or close to at least one of the fold-lines (3-8, 80-83).

22. An intermediate product (40) for an antenna device (1, 1′, 1″) and/or an antenna array (30) as claimed in claim 1, comprising:
a sheet shaped support (2, 200, 201) with a first structure and a second structure, which sheet shaped support (2, 200, 201) is foldable along a fold-line, by means of which folding a first support plane (10-13) with said first structure and a second support plane (10-13) with said second structure can be obtained, which first structure and second structure after folding the support (2, 200, 201) form at least a part of the first and second antenna structures (100).

23. A method for manufacturing an antenna device (1, 1′, 1″) or an antenna array as claimed in claim 1, comprising:
folding at least one sheet shaped support (2, 200, 201) provided with at least two antenna structures (100) along at least one fold-line, such that
at least one first support plane (10-13) adjacent to at least one of said fold-lines (3-8, 80-83), which first support plane (10-13) has at least one first antenna structure (100) arranged for receiving or emitting electro-magnetic radiation;
at least one second support plane (10-13) adjacent to at least one of said fold-lines (3-8, 80-83), which second support plane (10-13) is positioned at an angle with respect to the first support plane (10-13) and which second support plane (10-13) has at least one second antenna structure (100) arranged for receiving or emitting electro-magnetic radiation which differs in at least one property from the electro-magnetic radiation which can be received or emitted by said first antenna structure (100).
